(19) United States
(12) Patent Application Publication
(10) Pub. No.: US 2003/0020637 A1
(43) Pub. Date: Jan. 30, 2003

(54) Process making it possible to select a taxi from a fleet with a view to allocating it to be undertaken

(76) Inventor: Claude Ricard, Glencoe, IL (US)

Correspondence Address: BROWDY AND NEIMARK, P.L.L.C., 624 NINTH STREET, NW, SUITE 300, WASHINGTON, DC, 20001-5303, US

(21) Appl. No.: 10/207,190

(22) Filed: Jul. 29, 2002

(30) Foreign Application Priority Data
Jul. 27, 2001 (FR) 0110095

(51) Int. Cl. G08G 1/123

(52) U.S. Cl. 340/988; 340/994; 455/456

(57) ABSTRACT

A process making it possible to select a taxi from a fleet of taxis, with a view to allocating it a trip to be undertaken, this selection being a function of the position of the taxis and of the point of departure of the trip.

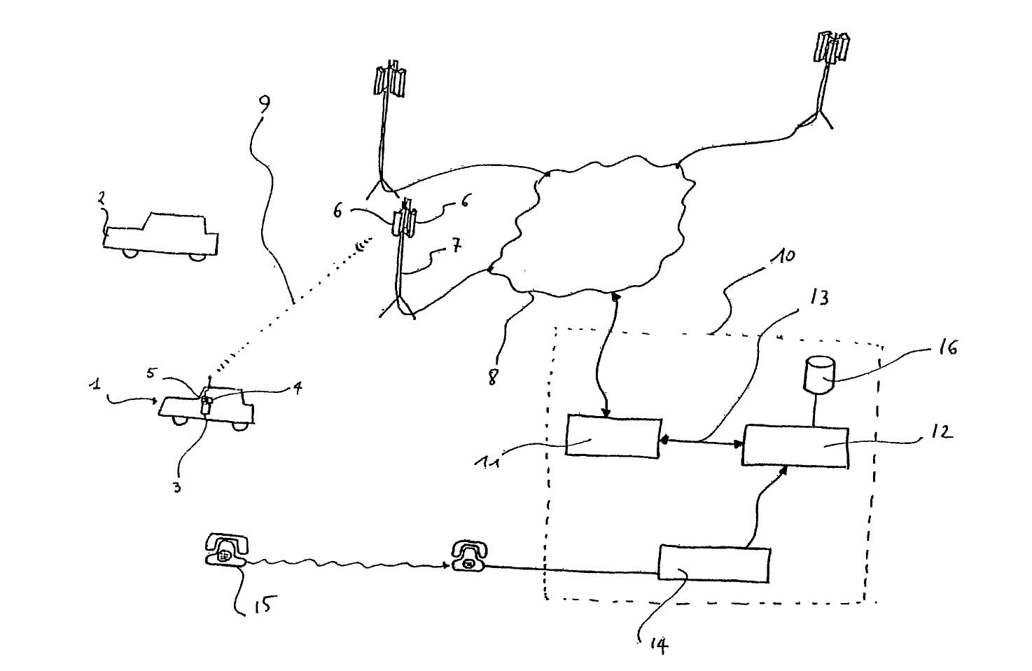

The process is one wherein:

the taxis are linked to a control center via a network to which the taxis are connected by a cellular radio link;

the position of each taxi is determined by the control center by virtue of the identifying of at least the last cellular radio link antenna via which the taxis was connected to the network.

### TECHNICAL FIELD

The invention pertains to the sector of activity of taxis. It relates more precisely to the processing of trip orders, generally referred to as “dispatching”, which makes it possible to select a taxi from a fleet of taxis, with a view to allocating it a trip to be undertaken. The invention makes it possible to carry out this operation with high accuracy while eliminating any risk of fraud or of poor functioning.

### PRIOR ART

In general, the operation of dispatching consists in processing the telephone calls from customers, and of determining which taxis of the fleet is closest, so as to indicate thereto that it should proceed to the place of departure of the forthcoming trip so as to pick up the customer.

The indications given by the customer are generally relied on in order to determine the point of departure of the trip. It is also possible, in a more advanced form, to use methods making it possible to locate the customer as a function of the telephone number of the line via which he calls the taxi company. In most cases, this information can be confirmed by the indications given by the customer.

The problem generally arises of determining the accurate position of the various taxis of the fleet, so as to make the most relevant selection.

To do this, various techniques have already been proposed, based on various means of communication between the taxi and the control center, also referred to as the “dispatching center”.

Thus, the great majority of taxis are linked to the control center by way of a radio link. This link allows the driver to indicate its position to the control center, and the latter to send the various items of information relating to the waiting trips. Thus, certain companies broadcast to the entire fleet the characteristics of the various trips which remain to be allocated. The driver is thus informed of the various trips that have come up, and when he considers that he is near a potential point of departure, he signals his positioning to the control center so as to solicit a particular trip. The control center determines whether the position announced by the driver is sufficiently close to the point of departure of the trip to be undertaken, and if it is, allocates this trip to the closest taxi which has just signaled its position.

This technique exhibits various drawbacks, and in particular that of requiring the continuous broadcasting of the various requests for trips to the taxi interior. The driver must then be continuously attentive to the messages which are announced, this possibly disturbing his concentration. Furthermore, these announcements constitute background sound which is annoying to the customers present in the taxi.

Finally, this method does not prevent drivers from announcing a position which does not correspond to their actual location. On the contrary, they may wittingly announce an erroneous position, for example that they are in an area of very high activity, where the demand for taxis is high. In this way, they are allocated trips, even if they are not in the most appropriate position for the forthcoming trip. Stated otherwise, there is risk of fraud when the position of the taxi is communicated solely by the intervention of the driver.

To facilitate the distributing operations, it has already been proposed that the zone of activity be cut up into various geographical areas, for example as a function of the districts or boroughs of a town. The driver can thus indicate which area he is in by entering a corresponding code into the keypad of the taximeter, so that this information is then transmitted to the control center. The control center can then send the messages regarding the forthcoming trips solely to the corresponding taxi of the area of the point of departure of the forthcoming trip.

This method comes up against other drawbacks. Specifically, the renting of radio link channels is relatively expensive, and the areas covered by these radio link antennas are relatively extensive. This implies that one is confronted with problems of saturation of these radio link channels when a large number of taxis are in the same area.

Furthermore, the problem of fraud alluded to above is not solved by this method, since the control center is informed of the position announced to it by the driver which may differ from the actual position.

To automate the locating operations, it has already been proposed that the various taxis be equipped with satellite-based locating systems, such as the systems known by the abbreviation “GPS” standing for “Global Positioning System”. This electronic system makes it possible, via the information received from at least three satellites, to determine the position of a moving point. However, the addition of a “GPS” type positioning system is not an ideal solution for at least two reasons. Specifically, “GPS” type positioning systems are relatively inaccurate when they are operating in town, and in particular in narrow streets or those bordered by relatively tall constructions. Specifically, in this case, the system might not receive the signals originating from three different satellites, thereby making it impossible to determine the position accurately. Stated otherwise, the “GPS” type system exhibits low accuracy in an urban environment. This is why the position determined automatically by a “GPS” type system is generally confirmed by data entered by the driver into the keypad of the taximeter. These data are then compared with any which may be given by the automatic locating system. Should there be inconsistency, it may be a matter either of poor functioning of the automatic locating system, or of attempted fraud by the driver. Sanctions may then be taken against the driver who attempted to commit fraud.

Another risk of fraud exists with the use of the “GPS” type automatic positioning system. Specifically, by wittingly disturbing the functioning of the antenna, for example by covering it with metal foil, it is possible to simulate being in an area where the GPS system functions poorly, while the taxi is in an area where such a system ought to function. The locating information processed by the control center then originates solely from the driver alone, with the abovementioned risks of fraud.

One of the objectives of the invention is that of preventing any attempted fraud through a determination of position resulting solely from the information transmitted by the driver.

Another objective of the invention is to do away with the information transmitted by the driver to determine the location of the taxi.

Another objective of the invention is to be able to determine the position of the taxi with precise accuracy which is greater than in the existing systems, in such a way as to optimize the dispatching, by determining the taxi which is actually closest to the point of departure of the forthcoming trip.

Another objective of the invention is that of transmitting the instructions for the forthcoming trips only to the taxis which are concerned, so as to avoid saturating the attention of the driver with irrelevant messages, and so as also not to upset the customer already present in the taxi through incessant messages.

### DESCRIPTION OF THE INVENTION

The invention therefore relates to a process making it possible to select a taxi from a fleet of taxis, with a view to allocating it a trip to be undertaken. This selection is made in a known manner as a function of the position of the various taxis of the fleet and of the point of departure of the trip.

In accordance with the invention, this process is one wherein:

the taxis are linked to a control center via a network to which the taxis are connected by a cellular radio link;

the position of each taxi is determined by the control center by virtue of the identifying of at least the last cellular radio link antenna via which the taxi was connected to the network.

Stated otherwise, it is by way of the system for communicating with the dispatching center that the taxi is located, without the driver having to intervene in this operation. It follows that the possibilities of fraud as mentioned hereinabove are impossible, since the information making it possible to determine the area in which the taxi is situated is transmitted automatically without possibility of intervention by the driver.

In the remainder of the description, the expression “cellular radio link” is understood to mean the links with a public network such as the networks used for mobile telephone communications. These links therefore encompass various types of networks known by the names “GSM”, “CDPD”, “MOTIENT” or the like. This type of cellular radio link operates with a very large number of antennas distributed in a grid of relatively small mesh, by comparison with the ranges of the radio antennas used in the known dispatching methods. The distance between antennas is of the order of a few kilometers and each antenna generally covers an area of one or two kilometers, this therefore corresponding to a relatively accurate cutting up of the zone of activity.

However, in areas of higher population density, such as in particular downtown, the density of such antennas is even greater. Thus, the process in accordance with the invention profits from the higher density of the cellular radio link antennas in the areas of higher population in which the requests for taxi trips are more numerous. The locating of the various taxis of the fleet is therefore more accurate in the areas of higher density, this making it possible to determine the taxis which are closest to the points of departure of the forthcoming trips. Distribution is thus optimized with a reduction in the waiting time of future customers.

In the subsequent description, the expression “cellular radio link antenna” is understood to mean not the tower on which the transmitting antennas are mounted, but the transmitting antenna itself. Specifically, on one and the same tower, and more generally at one and the same transmission site, is possible to install several transmitting antennas having different transmission lobes. Generally, these lobes have a 120° aperture, so that the whole area surrounding the tower is covered with three transmitting antennas. By virtue of the process in accordance with the invention, the position of each taxi is located inside an area defined by the transmission lobe of each antenna.

Thus, the communication means installed in the taxi receive the antenna's unique identification number via which they are connected to the network. This identification number is then transmitted to the control center by the communication network, possibly after processing. The control center analyzes the identification number of the tower (or the result of the processing of the identification number) so as to deduce therefrom the position of the taxi, and compare it with the position of the other taxis, as well as the position of the point of departure of the forthcoming trip.

Advantageously, it is possible also to use one or more references of antennas to which the taxi was previously connected so as to improve the definition of the position. This makes it possible in particular to verify the consistency of the successive positions.

In a particular form, the position of each taxi can be determined by also using information concerning the distance traveled by the taxi, or information concerning approximate direction or heading. Thus, by way of the communication system, the dispatching center can also receive periodically the distance traveled and possibly the approximate direction so as to refine the position. This distance and/or heading information is computed within the taxi, for example by virtue of sensors, and is generally processed by the taximeter. This information may also be determined by the control center which analyzes the succession of antennas to which the taxi was connected.

Advantageously, the position of each taxi can be determined by also using the signal level received from the cellular radio link antenna. This level makes it possible to evaluate the nearness of the antenna and thus to refine the determination of the position of the taxi inside one area corresponding to a particular antenna. The lobe of the antenna can thus be subdivided into several sections as a function of antenna remoteness, each section corresponding to a threshold of signal level received.

In practice, the determination of the position may be done at the level of the control center, which analyzes the identification number of the antenna. This position can also be determined within the taxi, which calculates position coordinates (or any other parameter defining its position) as a function of the identification number of the antenna to which it is connected. These coordinates are then transmitted to the control center. The position can also be refined in the taxi and then transmitted to the center.

Advantageously, in practice, the control center can also store the elapsed time for which each taxi has been connected to the network via the last antenna. Stated otherwise, it is thus possible to determine for how long the taxi has been in one particular area. This affords access to information regarding the activity of each taxi, and makes it possible optionally to take account of these parameters when allocating trips.

It is also possible to store the times for which each taxi has remained connected to the network via the previous antennas, with the identification of the latter, so as to refine the assessment of the activity, and optimize the dispatching.

In a particular form of embodiment, the control center may be furnished with a matrix containing the theoretical journey times between the areas each corresponding to a cellular radio link antenna, so as to determine for each taxi, the theoretical approach journey time to reach the point of departure of the trip.

In other words, the control center is furnished with data making it possible to ascertain the theoretical journey time to go from a given area to another given area. In this way, it is possible to determine, for the locating of a trip departure point, the theoretical approach journey time for each of the taxi. This theoretical time will be involved in the choice of the most appropriate taxi, in particular so as to minimize the customer's waiting time.

Advantageously, in practice, the matrix containing the theoretical journey times can vary according to the periods of the day and/or the traffic conditions. Thus, the theoretical times will be different depending on whether they relate to a peak period or to a period of freer flow. These theoretical times may possibly differ from one season to another, or as a function of weather conditions, or of particular traffic conditions corresponding to specific circumstances.

In a more sophisticated form, the theoretical journey times can be corrected as a function of measurements performed on earlier actual journeys. Specifically, the control center being constantly informed of the area (defined by the cellular radio link antenna) in which the taxi is situated, it will be able to calculate the actual journey time between the various areas crossed by the taxi during its trip. These various journey times may be analyzed and may serve to correct the theoretical time values used by the control center in respect of the dispatching operations.

In practice, the selection of the taxi for a trip to be undertaken, can be made as a function of the smallest theoretical journey time to get to the point of departure of the trip. In this procedure, the customer's waiting time is minimized by choosing the taxi which is closest time-wise to the point of departure of the trip.

According to another characteristic of the invention, he selection of the taxi may be made as a function of the smallest theoretical approach journey time, and also of the elapsed time for which the taxi has been connected to the last cellular radio link antenna.

In this case, the control center can take account of the duration for which the taxi has remained in the same area so as to choose between several taxis connected to the same antenna. This rule will be used more especially to determine which taxi to choose in areas where the order of arrival is an important factor. Thus, in stations or airports, the taxis waiting for a trip are parked in a queue. The control center can thus determine the time of arrival of the taxi in the area, and allocate the trip to the taxi which has been present for the longest duration.

The selection of the taxi may also be made not only as a function of the shortest theoretical approach journey time, but also as a function of other factors relating to operating rules. Thus, it is possible to take account, for each of the taxis, of the number of trips already undertaken during the day, or of a turnover generated by them, so as to allocate certain trips preferentially to this or that taxi, so as for example to even out the activity of the fleet. It may also be possible to take account of certain trips made in specific areas, regarded as risky areas or disadvantaged areas, so as to advantage certain taxis, that is to say to allocate them certain trips, preferentially to other taxis which are the same approach distance away. Conversely, this method may optionally make it possible to apply certain sanctions to taxis which have not made trips in these disadvantaged areas. The theoretical approach times for these taxis will then be augmented as a function of the taxis company's operating rules.

According to another characteristic of the invention, the control center performs two distinct tasks, namely:

a communication task for communicating with all the taxis of the fleet, so as to determine their position, and to send them the instructions corresponding to the trips to be undertaken;

a processing task, so as to determine one taxi from the fleet, as a function of the positions of the taxis of the fleet, and of the point of departure of the trip.

Thus, one of the functions of the control center is to communicate with the various taxis via the characteristic network, in such a way as to ascertain the position of the various taxis of the fleet with the minimum of delay. Another function of the control center is to analyze these various positions and to determine in respect of a forthcoming trip, which taxi is the most appropriate, taking account of the various approach time or other factors mentioned hereinabove.

In practice, the processing task generates, for sending to the communication task a message containing the instructions for the trip to be undertaken. The communication task then sends the instructions message to the selected taxi. These instructions may then be displayed, or announced for example by a voice signal, or more generally be signaled to the driver of the taxi selected.

Advantageously, in practice, the communication and processing tasks are undertaken on two separate computers, linked by a high bit rate link. The functioning of the control center is thus optimized by relieving a computer of the communication task, and a second computer of executing the algorithm for determining the most appropriate taxi to undertake the forthcoming trip.

The invention also relates to an electronic device installed in the taxi and equipped with a communication modem, able to be connected to a network via a cellular radio type link. This device incorporates electronic means for participating in the process described hereinabove. This electronic device can either be incorporated inside a taximeter, or else form the subject of an independent box which is mounted in the taxi, and possibly linked to the taximeter.

### BRIEF DESCRIPTION OF THE FIGURES

The manner of embodying the invention as well as the advantages which stem therefrom will emerge clearly from the description of the mode of embodiment which follows, in support of the single appended figure which diagrammatically represents the various elements involved in the implementation of the dispatching process in accordance with the invention.

### MANNER OF EMBODYING THE INVENTION

As illustrated in the figure, the various taxis (1, 2) are equipped with a taximeter (3) which comprises an electronic card (4) equipped with a connector intended to receive a modem (5). It may for example be a “PCMCIA” type connector able to receive a digital data transmission modem or an “RSC232” type serial connection. This modem may be of the type able to connect up to “GSM”, “CDPD” (standing for Cellular Digital Packet Data) type networks, or else “MOTIENT” networks, or more generally any digital wireless communication network. This modem (5) is able to exchange digital data, for example according to the TCP/IP protocol when it is connected to a transmission/reception antenna (6) of the corresponding network (8).

As already mentioned, one and the same tower (7) can support several transmission/reception antennas (6) of the same network, whose various lobes supplement one another so as to ensure coverage of the whole of the adjoining area. Upon connection of the modem (5) with the corresponding antenna (6), the latter transmits a unique identification number for the antenna to the modem. This number is processed by the electronics integrated into the taximeter or with a box of its own, and transmitted in a message bound for the control center. This message is forwarded by the antenna to a public network, ending up at the control center (10).

More precisely, the message reaches that part (11) of the control center (10) which is dedicated to communication with the various taxis. This part (11) of the control center (10) therefore updates a database containing the antenna numbers to which the taxis are connected. When communication with a taxi is no longer possible, for example because the taxi is out of range of a link antenna, the identification of the last tower to which the modem was connected is held in memory by the control center.

The positions of the various taxis are transmitted to a second computer (12) of the control center (10). This other part (12) of the control center performs the processing task allowing the allotting of a taxi to a trip to be undertaken. The link (13) between the two computers (11, 12) of the control center (10) exhibits a sufficiently high bit rate for the processing task to be able to take account of the positions of the taxis which are as up-to-date as possible so as to perform optimal dispatching. This link (13) may be local or relatively remote, thereby making it possible to differentiate physically between the communication and processing tasks, and to perform them on remote sites, for example.

The processing task is also in touch with a call center (14) which receives the calls (15) originating from the various customers. This call center (14) makes it possible to determine the position of the point of departure of the forthcoming trips. This determination can take place via the processing of the particulars given by the customer (15). It may also be supplemented with an automatic determination as a function of the call number identified by the call center (14). The position of the point of departure of the forthcoming trip is transmitted to the processing task (12) by the call center (14) in the form of Cartesian coordinates which may be coded in the form of the identification number of the cellular link antenna closest to the point of departure of the trip.

The processing task (12) therefore next calculates the theoretical approach time for each of the taxis to get to the point of departure of the forthcoming trip. As a function of the theoretical time, and of other factors mentioned previously, the processing task selects the taxi to which the forthcoming trip will be allocated. The processing task next formats a message incorporating the characteristics of the instructions for the forthcoming trip and transmits this message to the communication task (11). This message is next sent via the public network (8) to the selected taxi (1), identified by its unique address. This address may advantageously be an IP address when the dialog protocol used is of the TCP/IP type. The selected taxi is therefore the only one to receive the message corresponding to the forthcoming trip, and the driver is thus advised of the next trip which he is to make.

The processing task (12) calculates the theoretical journey times by loading matrices of theoretical journey times recorded in a storage unit. These models of theoretical journey times may be changed with a periodicity determined in advance, so as to correspond to alterations in the traffic flow conditions. These conditions may as already stated depend on the time of day, on climatic conditions, or on particular traffic conditions. The journey time models may also be corrected as a function of the various actual journey times analyzed with regard to trips which have already been made.

It emerges from the foregoing that the process in accordance with the invention possesses multiple advantages, and in particular:

it allows greater accuracy in the determination of the position of the taxi, on account of the fine-meshed grid of the network of cellular radio link antennas;

it benefits from the greater density of cellular radio link antennas in the areas where the potential number of taxi trips is biggest, that is to say in the areas of higher population density; this higher density ensures better accuracy in the determination of the suitable taxi, without being subject to network saturation problems;

it makes it possible to manage the dispatching as a function of particular operating rules which may be complex;

it eliminates the risks of fraud on account of the fact that in no case does the position of the taxi depend on parameters input by the driver;

it offers a more reliable and more economical solution by dispensing with automatic locating devices of the GPS type;

it offers a modular solution which adapts to any size of fleet and which allows any alteration in the number of vehicles without reappraisal of the infrastructure.

1. A process making it possible to select a taxi (1) from a fleet of taxis, with a view to allocating it a trip to be undertaken, this selection being a function of the position of the taxis and of the point of departure of the trip, wherein:
the taxis (1, 2) are linked to a control center (10) via a network (8) to which the taxis are connected by a cellular radio link (9);
the position of each taxi (1, 2) is determined (10) by virtue of the identifying of at least the last cellular radio link antenna (6) via which the taxi (1) was connected to the network (8).

2. The process as claimed in claim 1, in which the position of each taxi is determined by also using information concerning distance traveled by the taxi.

3. The process as claimed in claim 1, in which the position of each taxi is determined by also using information concerning heading.

4. The process as claimed in claim 1, in which the position of each taxi is determined by also using information concerning signal level received from the cellular radio link antenna (6).

5. The process as claimed in claim 1, in which the position of each taxi (1, 2) is determined by the control center.

6. The process as claimed in claim 1, in which the position of each taxi is determined by means on board the taxi, this position then being transmitted to the control center.

7. The process as claimed in claim 1, in which the control center (10) stores the elapsed time for which each taxi has been connected to the network via the last antenna (6).

8. The process as claimed in claim 7, in which the control center stores the times for which each taxi has remained connected to the network via the previous antennas, with the identification of the latter.

9. The process as claimed in claim 1, in which the control center (10) is furnished with a matrix containing the theoretical journey times between the areas each corresponding to a cellular radio link antenna, so as to determine for each taxi, the theoretical approach journey time to reach the point of departure of the trip.

10. The process as claimed in claim 4, in which the matrix containing the theoretical journey times can vary according to the periods of the day and/or the traffic conditions.

11. The process as claimed in claim 10, in which the theoretical journey times are corrected as a function of measurements performed on earlier actual journeys.

12. The process as claimed in claim 9, in which the selection of the taxi is made as a function of the smallest theoretical journey time to get to the point of departure of the trip.

13. The process as claimed in claim 9, in which the selection of the taxi is made as a function of the smallest theoretical journey time to get to the point of departure of the trip, and also of factors relating to operating rules.

14. The process as claimed in claims 7 and 9, in which the selection of the taxi is made as a function of the smallest theoretical journey time to get to the point of departure of the trip, and also of the elapsed time for which the taxi has been connected to the last cellular radio link antenna.

15. The process as claimed in claim 1, in which the control center (10) performs two distinct tasks, namely:
a communication task (11) for communicating with all the taxis of the fleet, so as to determine their position, and to send them the instructions corresponding to the trips to be undertaken;
a processing task (12), so as to determine one taxi from the fleet, as a function of the positions of the taxis of the fleet, and of the point of departure of the trip.

16. The process as claimed in claim 15, in which the processing task (2) generates, for sending to the communication task (11) a message containing the instructions for the trip to be undertaken, and in which the communication task (11) sends said message to the selected taxi.

17. The process as claimed in claim 15, in which the communication and processing tasks are undertaken on two seperate computers (11, 12), linked by a high bit rate link.

18. An electronic device equipped with a communication modem (5), able to be connected to a network via a cellular radio type link, and incorporating electronic means for participating in the process as claimed in one of claims 1 to 17.

19. A taximeter incorporating an electronic device as claimed in claim 18.
